(19) United States
(12) Patent Application Publication
(10) Pub. No.: US 2021/0217014 A1
(43) Pub. Date: Jul. 15, 2021

(54) Method, System, and Computer Program Product for Co-Located Merchant Anomaly Detection

(71) Applicant: Visa International Service Association, San Francisco, CA (US)

(72) Inventors: Abhinaya Babu Shetty, Sunnyvale, CA (US); Mohit Umesh Kudalkar, Milpitas, CA (US); Kushal Ravindra Kokje, San Carlos, CA (US)

(21) Appl. No.: 16/738,377

(22) Filed: Jan. 9, 2020

(51) Int. Cl. G06Q 20/40; G06N 20/00; G06F 17/18; G06K 9/62

(52) U.S. Cl. CPC G06Q 20/4014; G06K 9/6267; G06F 17/18; G06N 20/00

(57) ABSTRACT

A method, system, and computer program product for co-located merchant anomaly detection obtain prior transaction data associated with a plurality of prior transactions, a first subset being associated with a first merchant, a second subset being associated with a second merchant, each prior transaction being associated with a same merchant location in the prior transaction data, and each prior transaction being associated with a same merchant name in the prior transaction data; extract a plurality of features associated with the plurality of prior transactions from the prior transaction data; and train based on the plurality of features associated with the plurality of prior transactions and labels for the prior transactions, a machine learning model to determine at least one of a prediction of whether a transaction is associated with the first merchant and a prediction of whether the transaction is associated with the second merchant.

### BACKGROUND

### 1. Field

This disclosure relates generally to systems, devices, products, apparatus, and methods that are used for identifying merchant names, and in some embodiments or aspects, to a method, a system, and a product for co-located merchant anomaly detection.

### 2. Technical Considerations

A merchant name included in transaction data does not always correctly reflect the actual merchant associated with a transaction. For example, some co-located merchants may have the same merchant name in the transaction data for transactions at those co-located merchants. For example, a MoneyGram store located inside a Walmart store may have a same merchant name included in the transaction data for a transaction at the MoneyGram store as the transaction data for a transaction at the Walmart store (e.g., a merchant name of Walmart for each transaction instead of a transaction merchant name MoneyGram associated with the transaction at the MoneyGram store and a transaction merchant name Walmart associated with the transaction at the Walmart store, etc.). This makes it difficult to identify multiple merchants at the same location correctly, which may cause incorrect grouping of such merchants under the same name, and may lead to misclassification of transactions and incorrect volume reporting.

### SUMMARY

Accordingly, provided are improved systems, devices, products, apparatus, and/or methods for co-located merchant anomaly detection.

According to some non-limiting embodiments or aspects, provided is a computer-implemented method, comprising: obtaining, with at least one processor, prior transaction data associated with a plurality of prior transactions, wherein a first subset of the prior transactions is associated with a first merchant, wherein a second subset of the prior transactions is associated with a second merchant different than the first merchant, wherein each prior transaction of the plurality of prior transactions is associated with a same merchant location in the prior transaction data, wherein each prior transaction of the plurality of prior transactions is associated with a same merchant name in the prior transaction data, wherein the same merchant name is associated with the first merchant, wherein a different merchant name than the same merchant name is associated with the second merchant, wherein a first portion of the plurality of prior transactions is labeled as misclassified merchant transactions, and wherein a second portion of the plurality of prior transactions is labeled as other merchant transactions; extracting, with at least one processor, a plurality of features associated with the plurality of prior transactions from the prior transaction data; and training, with at least one processor, based on the plurality of features associated with the plurality of prior transactions and the labels for the prior transactions, a machine learning model to determine at least one of a prediction of whether a transaction is associated with the first merchant and a prediction of whether the transaction is associated with the second merchant.

In some non-limiting embodiments or aspects, training the machine learning model further comprises: training, based on the plurality of features associated with the plurality of prior transactions and the labels for the prior transactions, a first machine learning classifier associated with the first merchant to determine a first prediction of whether the transaction is associated with the first merchant; and training, based on the plurality of features associated with the plurality of prior transactions and the labels for the prior transactions, a second machine learning classifier associated with the second merchant to determine a second prediction of whether the transaction is associated with the second merchant.

In some non-limiting embodiments or aspects, the method further comprises: providing, with at least one processor, the trained machine learning model; obtaining, with at least one processor, transaction data associated with the transaction; extracting, with at least one processor, a plurality of features associated with the transaction from the transaction data; and processing, with at least one processor using the trained machine learning model, the plurality of features to determine the first prediction of whether the transaction is associated with the first merchant and the second prediction of whether the transaction is associated with the second merchant, wherein the first prediction includes a first probability associated with the transaction being associated with the first merchant, and wherein the second prediction includes a second probability associated with the transaction being associated with the second merchant.

In some non-limiting embodiments or aspects, the method further comprises: comparing, with at least one processor, at least one of the first probability and the second probability to at least one threshold probability; determining, with at least one processor, based on the comparison, that the at least one of the first probability and the second probability fails to satisfy the at least one threshold probability; in response to determining that the at least one of the first probability and the second probability fails to satisfy the at least one threshold probability, comparing, with at least one processor, at least one feature of the plurality of features associated with the transaction to a first customer spend pattern associated with the first merchant and a second customer spend pattern associated with the second merchant; and determining, with at least one processor, based on the comparison, that the transaction is associated with the first merchant or the second merchant.

In some non-limiting embodiments or aspects, the first merchant is associated with at least one known merchant category group, wherein the plurality of prior transactions is clustered in a plurality of groups according to merchant category groups associated with the plurality of prior transactions in the prior transaction data, wherein at least one group of the plurality of groups is identified as an anomalous group, wherein the at least one anomalous group includes transactions outside the at least one known merchant category group associated with the first merchant, and wherein the transactions in the at least one anomalous group are labeled as the misclassified merchant transactions or the other merchant transactions according to the at least one known merchant category group associated with the first merchant.

In some non-limiting embodiments or aspects, the plurality of features associated with the plurality of prior transactions includes at least one of: a merchant category code (MCC), a merchant name, an average transaction amount associated with a merchant name, a transaction time associated with a prior transaction, or any combination thereof.

In some non-limiting embodiments or aspects, the machine learning model includes at least one random forest model.

According to some non-limiting embodiments or aspects, provided is a computing system comprising: one or more processors programmed and/or configured to: obtain prior transaction data associated with a plurality of prior transactions, wherein a first subset of the prior transactions is associated with a first merchant, wherein a second subset of the prior transactions is associated with a second merchant different than the first merchant, wherein each prior transaction of the plurality of prior transactions is associated with a same merchant location in the prior transaction data, wherein each prior transaction of the plurality of prior transactions is associated with a same merchant name in the prior transaction data, wherein the same merchant name is associated with the first merchant, wherein a different merchant name than the same merchant name is associated with the second merchant, wherein a first portion of the plurality of prior transactions is labeled as misclassified merchant transactions, and wherein a second portion of the plurality of prior transactions is labeled as other merchant transactions; extract a plurality of features associated with the plurality of prior transactions from the prior transaction data; and train, based on the plurality of features associated with the plurality of prior transactions and the labels for the prior transactions, a machine learning model to determine at least one of a prediction of whether a transaction is associated with the first merchant and a prediction of whether the transaction is associated with the second merchant.

In some non-limiting embodiments or aspects, the one or more processors train the machine learning model by: training, based on the plurality of features associated with the plurality of prior transactions and the labels for the prior transactions, a first machine learning classifier associated with the first merchant to determine a first prediction of whether the transaction is associated with the first merchant; and training, based on the plurality of features associated with the plurality of prior transactions and the labels for the prior transactions, a second machine learning classifier associated with the second merchant to determine a second prediction of whether the transaction is associated with the second merchant.

In some non-limiting embodiments or aspects, the one or more processors are further programmed and/or configured to: provide the trained machine learning model; obtain transaction data associated with the transaction; extract a plurality of features associated with the transaction from the transaction data; and process, using the trained machine learning model, the plurality of features to determine the first prediction of whether the transaction is associated with the first merchant and the second prediction of whether the transaction is associated with the second merchant, wherein the first prediction includes a first probability associated with the transaction being associated with the first merchant, and wherein the second prediction includes a second probability associated with the transaction being associated with the second merchant.

In some non-limiting embodiments or aspects, the one or more processors are further programmed and/or configured to: compare at least one of the first probability and the second probability to at least one threshold probability; determine, based on the comparison, that the at least one of the first probability and the second probability fails to satisfy the at least one threshold probability; in response to determining that the at least one of the first probability and the second probability fails to satisfy the at least one threshold probability, compare at least one feature of the plurality of features associated with the transaction to a first customer spend pattern associated with the first merchant and a second customer spend pattern associated with the second merchant; and determine, based on the comparison, that the transaction is associated with the first merchant or the second merchant.

In some non-limiting embodiments or aspects, the first merchant is associated with at least one known merchant category group, wherein the plurality of prior transactions is clustered in a plurality of groups according to merchant category groups associated with the plurality of prior transactions in the prior transaction data, wherein at least one group of the plurality of groups is identified as an anomalous group, wherein the at least one anomalous group includes transactions outside the at least one known merchant category group associated with the first merchant, and wherein the transactions in the at least one anomalous group are labeled as the misclassified merchant transactions or the other merchant transactions according to the at least one known merchant category group associated with the first merchant.

In some non-limiting embodiments or aspects, the plurality of features associated with the plurality of prior transactions includes at least one of: a merchant category code (MCC), a merchant name, an average transaction amount associated with a merchant name, a transaction time associated with a prior transaction, or any combination thereof.

In some non-limiting embodiments or aspects, the machine learning model includes at least one random forest model.

According to some non-limiting embodiments or aspects, provided is a computer program product comprising at least one non-transitory computer-readable medium including program instructions that, when executed by at least one processor, cause the at least one processor to: obtain prior transaction data associated with a plurality of prior transactions, wherein a first subset of the prior transactions is associated with a first merchant, wherein a second subset of the prior transactions is associated with a second merchant different than the first merchant, wherein each prior transaction of the plurality of prior transactions is associated with a same merchant location in the prior transaction data, wherein each prior transaction of the plurality of prior transactions is associated with a same merchant name in the prior transaction data, wherein the same merchant name is associated with the first merchant, wherein a different merchant name than the same merchant name is associated with the second merchant, wherein a first portion of the plurality of prior transactions is labeled as misclassified merchant transactions, and wherein a second portion of the plurality of prior transactions is labeled as other merchant transactions; extract a plurality of features associated with the plurality of prior transactions from the prior transaction data; and train, based on the plurality of features associated with the plurality of prior transactions and the labels for the prior transactions, a machine learning model to determine at least one of a prediction of whether a transaction is associated with the first merchant and a prediction of whether the transaction is associated with the second merchant.

In some non-limiting embodiments or aspects, the instructions cause the at least one processor to train the machine learning model by: training, based on the plurality of features associated with the plurality of prior transactions and the labels for the prior transactions, a first machine learning classifier associated with the first merchant to determine a first prediction of whether the transaction is associated with the first merchant; and training, based on the plurality of features associated with the plurality of prior transactions and the labels for the prior transactions, a second machine learning classifier associated with the second merchant to determine a second prediction of whether the transaction is associated with the second merchant.

In some non-limiting embodiments or aspects, the instructions further cause the at least one processor to: provide the trained machine learning model; obtain transaction data associated with the transaction; extract a plurality of features associated with the transaction from the transaction data; and process, using the trained machine learning model, the plurality of features to determine the first prediction of whether the transaction is associated with the first merchant and the second prediction of whether the transaction is associated with the second merchant, wherein the first prediction includes a first probability associated with the transaction being associated with the first merchant, and wherein the second prediction includes a second probability associated with the transaction being associated with the second merchant.

In some non-limiting embodiments or aspects, the instructions further cause the at least one processor to: compare at least one of the first probability and the second probability to at least one threshold probability; determine, based on the comparison, that the at least one of the first probability and the second probability fails to satisfy the at least one threshold probability; in response to determining that the at least one of the first probability and the second probability fails to satisfy the at least one threshold probability, compare, at least one feature of the plurality of features associated with the transaction to a first customer spend pattern associated with the first merchant and a second customer spend pattern associated with the second merchant; and determine, based on the comparison, that the transaction is associated with the first merchant or the second merchant.

In some non-limiting embodiments or aspects, the first merchant is associated with at least one known merchant category group, wherein the plurality of prior transactions is clustered in a plurality of groups according to merchant category groups associated with the plurality of prior transactions in the prior transaction data, wherein at least one group of the plurality of groups is identified as an anomalous group, wherein the at least one anomalous group includes transactions outside the at least one known merchant category group associated with the first merchant, and wherein the transactions in the at least one anomalous group are labeled as the misclassified merchant transactions or the other merchant transactions according to the at least one known merchant category group associated with the first merchant.

In some non-limiting embodiments or aspects, the plurality of features associated with the plurality of prior transactions includes at least one of: a merchant category code (MCC), a merchant name, an average transaction amount associated with a merchant name, a transaction time associated with a prior transaction, or any combination thereof.

Further embodiments or aspects are set forth in the following numbered clauses:

Clause 1. A computer-implemented method, comprising: obtaining, with at least one processor, prior transaction data associated with a plurality of prior transactions, wherein a first subset of the prior transactions is associated with a first merchant, wherein a second subset of the prior transactions is associated with a second merchant different than the first merchant, wherein each prior transaction of the plurality of prior transactions is associated with a same merchant location in the prior transaction data, wherein each prior transaction of the plurality of prior transactions is associated with a same merchant name in the prior transaction data, wherein the same merchant name is associated with the first merchant, wherein a different merchant name than the same merchant name is associated with the second merchant, wherein a first portion of the plurality of prior transactions is labeled as misclassified merchant transactions, and wherein a second portion of the plurality of prior transactions is labeled as other merchant transactions; extracting, with at least one processor, a plurality of features associated with the plurality of prior transactions from the prior transaction data; and training, with at least one processor, based on the plurality of features associated with the plurality of prior transactions and the labels for the prior transactions, a machine learning model to determine at least one of a prediction of whether a transaction is associated with the first merchant and a prediction of whether the transaction is associated with the second merchant.

Clause 2. The computer-implemented method of clause 1, wherein training the machine learning model further comprises: training, based on the plurality of features associated with the plurality of prior transactions and the labels for the prior transactions, a first machine learning classifier associated with the first merchant to determine a first prediction of whether the transaction is associated with the first merchant; and training, based on the plurality of features associated with the plurality of prior transactions and the labels for the prior transactions, a second machine learning classifier associated with the second merchant to determine a second prediction of whether the transaction is associated with the second merchant.

Clause 3. The computer-implemented method of clauses 1 or 2, further comprising: providing, with at least one processor, the trained machine learning model; obtaining, with at least one processor, transaction data associated with the transaction; extracting, with at least one processor, a plurality of features associated with the transaction from the transaction data; and processing, with at least one processor using the trained machine learning model, the plurality of features to determine the first prediction of whether the transaction is associated with the first merchant and the second prediction of whether the transaction is associated with the second merchant, wherein the first prediction includes a first probability associated with the transaction being associated with the first merchant, and wherein the second prediction includes a second probability associated with the transaction being associated with the second merchant.

Clause 4. The computer-implemented method of any of clauses 1-3, further comprising: comparing, with at least one processor, at least one of the first probability and the second probability to at least one threshold probability; determining, with at least one processor, based on the comparison, that the at least one of the first probability and the second probability fails to satisfy the at least one threshold probability; in response to determining that the at least one of the first probability and the second probability fails to satisfy the at least one threshold probability, comparing, with at least one processor, at least one feature of the plurality of features associated with the transaction to a first customer spend pattern associated with the first merchant and a second customer spend pattern associated with the second merchant; and determining, with at least one processor, based on the comparison, that the transaction is associated with the first merchant or the second merchant.

Clause 5. The computer-implemented method of any of clauses 1-4, wherein the first merchant is associated with at least one known merchant category group, wherein the plurality of prior transactions is clustered in a plurality of groups according to merchant category groups associated with the plurality of prior transactions in the prior transaction data, wherein at least one group of the plurality of groups is identified as an anomalous group, wherein the at least one anomalous group includes transactions outside the at least one known merchant category group associated with the first merchant, and wherein the transactions in the at least one anomalous group are labeled as the misclassified merchant transactions or the other merchant transactions according to the at least one known merchant category group associated with the first merchant.

Clause 6. The computer-implemented method of any of clauses 1-5, wherein the plurality of features associated with the plurality of prior transactions includes at least one of: a merchant category code (MCC), a merchant name, an average transaction amount associated with a merchant name, a transaction time associated with a prior transaction, or any combination thereof.

Clause 7. The computer-implemented method of any of clauses 1-6, wherein the machine learning model includes at least one random forest model.

Clause 8. A computing system comprising: one or more processors programmed and/or configured to: obtain prior transaction data associated with a plurality of prior transactions, wherein a first subset of the prior transactions is associated with a first merchant, wherein a second subset of the prior transactions is associated with a second merchant different than the first merchant, wherein each prior transaction of the plurality of prior transactions is associated with a same merchant location in the prior transaction data, wherein each prior transaction of the plurality of prior transactions is associated with a same merchant name in the prior transaction data, wherein the same merchant name is associated with the first merchant, wherein a different merchant name than the same merchant name is associated with the second merchant, wherein a first portion of the plurality of prior transactions is labeled as misclassified merchant transactions, and wherein a second portion of the plurality of prior transactions is labeled as other merchant transactions; extract a plurality of features associated with the plurality of prior transactions from the prior transaction data; and train, based on the plurality of features associated with the plurality of prior transactions and the labels for the prior transactions, a machine learning model to determine at least one of a prediction of whether a transaction is associated with the first merchant and a prediction of whether the transaction is associated with the second merchant.

Clause 9. The computing system of clause 8, wherein the one or more processors train the machine learning model by: training, based on the plurality of features associated with the plurality of prior transactions and the labels for the prior transactions, a first machine learning classifier associated with the first merchant to determine a first prediction of whether the transaction is associated with the first merchant; and training, based on the plurality of features associated with the plurality of prior transactions and the labels for the prior transactions, a second machine learning classifier associated with the second merchant to determine a second prediction of whether the transaction is associated with the second merchant.

Clause 10. The computing system of clauses 8 or 9, wherein the one or more processors are further programmed and/or configured to: provide the trained machine learning model; obtain transaction data associated with the transaction; extract a plurality of features associated with the transaction from the transaction data; and process, using the trained machine learning model, the plurality of features to determine the first prediction of whether the transaction is associated with the first merchant and the second prediction of whether the transaction is associated with the second merchant, wherein the first prediction includes a first probability associated with the transaction being associated with the first merchant, and wherein the second prediction includes a second probability associated with the transaction being associated with the second merchant.

Clause 11. The computing system of any of clauses 8-10, wherein the one or more processors are further programmed and/or configured to: compare at least one of the first probability and the second probability to at least one threshold probability; determine, based on the comparison, that the at least one of the first probability and the second probability fails to satisfy the at least one threshold probability; in response to determining that the at least one of the first probability and the second probability fails to satisfy the at least one threshold probability, compare at least one feature of the plurality of features associated with the transaction to a first customer spend pattern associated with the first merchant and a second customer spend pattern associated with the second merchant; and determine, based on the comparison, that the transaction is associated with the first merchant or the second merchant.

Clause 12. The computing system of any of clauses 8-11, wherein the first merchant is associated with at least one known merchant category group, wherein the plurality of prior transactions is clustered in a plurality of groups according to merchant category groups associated with the plurality of prior transactions in the prior transaction data, wherein at least one group of the plurality of groups is identified as an anomalous group, wherein the at least one anomalous group includes transactions outside the at least one known merchant category group associated with the first merchant, and wherein the transactions in the at least one anomalous group are labeled as the misclassified merchant transactions or the other merchant transactions according to the at least one known merchant category group associated with the first merchant.

Clause 13. The computing system of any of clauses 8-12, wherein the plurality of features associated with the plurality of prior transactions includes at least one of: a merchant category code (MCC), a merchant name, an average transaction amount associated with a merchant name, a transaction time associated with a prior transaction, or any combination thereof.

Clause 14. The computing system of any of clauses 8-13, wherein the machine learning model includes at least one random forest model.

Clause 15. A computer program product comprising at least one non-transitory computer-readable medium including program instructions that, when executed by at least one processor, cause the at least one processor to: obtain prior transaction data associated with a plurality of prior transactions, wherein a first subset of the prior transactions is associated with a first merchant, wherein a second subset of the prior transactions is associated with a second merchant different than the first merchant, wherein each prior transaction of the plurality of prior transactions is associated with a same merchant location in the prior transaction data, wherein each prior transaction of the plurality of prior transactions is associated with a same merchant name in the prior transaction data, wherein the same merchant name is associated with the first merchant, wherein a different merchant name than the same merchant name is associated with the second merchant, wherein a first portion of the plurality of prior transactions is labeled as misclassified merchant transactions, and wherein a second portion of the plurality of prior transactions is labeled as other merchant transactions; extract a plurality of features associated with the plurality of prior transactions from the prior transaction data; and train, based on the plurality of features associated with the plurality of prior transactions and the labels for the prior transactions, a machine learning model to determine at least one of a prediction of whether a transaction is associated with the first merchant and a prediction of whether the transaction is associated with the second merchant.

Clause 16. The computer program product of clause 15, wherein the instructions cause the at least one processor to train the machine learning model by: training, based on the plurality of features associated with the plurality of prior transactions and the labels for the prior transactions, a first machine learning classifier associated with the first merchant to determine a first prediction of whether the transaction is associated with the first merchant; and training, based on the plurality of features associated with the plurality of prior transactions and the labels for the prior transactions, a second machine learning classifier associated with the second merchant to determine a second prediction of whether the transaction is associated with the second merchant.

Clause 17. The computer program product of clauses 15 or 16, wherein the instructions further cause the at least one processor to: provide the trained machine learning model; obtain transaction data associated with the transaction; extract a plurality of features associated with the transaction from the transaction data; and process, using the trained machine learning model, the plurality of features to determine the first prediction of whether the transaction is associated with the first merchant and the second prediction of whether the transaction is associated with the second merchant, wherein the first prediction includes a first probability associated with the transaction being associated with the first merchant, and wherein the second prediction includes a second probability associated with the transaction being associated with the second merchant.

Clause 18. The computer program product of any of clauses 15-17, wherein the instructions further cause the at least one processor to: compare at least one of the first probability and the second probability to at least one threshold probability; determine, based on the comparison, that the at least one of the first probability and the second probability fails to satisfy the at least one threshold probability; in response to determining that the at least one of the first probability and the second probability fails to satisfy the at least one threshold probability, compare, at least one feature of the plurality of features associated with the transaction to a first customer spend pattern associated with the first merchant and a second customer spend pattern associated with the second merchant; and determine, based on the comparison, that the transaction is associated with the first merchant or the second merchant.

Clause 19. The computer program product of any of clauses 15-18, wherein the first merchant is associated with at least one known merchant category group, wherein the plurality of prior transactions is clustered in a plurality of groups according to merchant category groups associated with the plurality of prior transactions in the prior transaction data, wherein at least one group of the plurality of groups is identified as an anomalous group, wherein the at least one anomalous group includes transactions outside the at least one known merchant category group associated with the first merchant, and wherein the transactions in the at least one anomalous group are labeled as the misclassified merchant transactions or the other merchant transactions according to the at least one known merchant category group associated with the first merchant.

Clause 20. The computer program product of any of clauses 15-19, wherein the plurality of features associated with the plurality of prior transactions includes at least one of: a merchant category code (MCC), a merchant name, an average transaction amount associated with a merchant name, a transaction time associated with a prior transaction, or any combination thereof.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of limits. As used in the specification and the claims, the singular form of “a,” “an,” and “the” include plural referents unless the context clearly dictates otherwise.

### BRIEF DESCRIPTION OF THE DRAWINGS

Additional advantages and details are explained in greater detail below with reference to the exemplary embodiments or aspects that are illustrated in the accompanying schematic figures, in which:

FIG. 1 is a diagram of non-limiting embodiments or aspects of an environment in which systems, devices, products, apparatus, and/or methods, described herein, may be implemented;

FIG. 2 is a diagram of non-limiting embodiments or aspects of components of one or more devices and/or one or more systems of FIG. 1;

FIG. 3 is a flowchart of non-limiting embodiments or aspects of a process for co-located merchant anomaly detection;

FIG. 4 is a flowchart of non-limiting embodiments or aspects of a process for co-located merchant anomaly detection; and

FIG. 5 is a flowchart of non-limiting embodiments or aspects of a process for co-located merchant anomaly detection.

### DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

It will be apparent that systems and/or methods, described herein, can be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

As used herein, the term “transaction service provider” may refer to an entity that receives transaction authorization requests from merchants or other entities and provides guarantees of payment, in some cases through an agreement between the transaction service provider and an issuer institution. The terms “transaction service provider” and “transaction service provider system” may also refer to one or more computer systems operated by or on behalf of a transaction service provider, such as a transaction processing system executing one or more software applications. A transaction processing system may include one or more server computers with one or more processors and, in some non-limiting embodiments or aspects, may be operated by or on behalf of a transaction service provider.

As used herein, the term “account identifier” may include one or more Primary Account Numbers (PAN), tokens, or other identifiers (e.g., a globally unique identifier (GUID), a universally unique identifier (UUID), etc.) associated with a customer account of a user (e.g., a customer, a consumer, and/or the like). The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more databases such that they can be used to conduct a transaction without directly using the original account identifier. In some examples, an original account identifier, such as a PAN, may be associated with a plurality of tokens for different individuals or purposes.

As used herein, the terms “issuer institution,” “portable financial device issuer,” “issuer,” or “issuer bank” may refer to one or more entities that provide one or more accounts to a user (e.g., a customer, a consumer, an entity, an organization, and/or the like) for conducting transactions (e.g., payment transactions), such as initiating credit card payment transactions and/or debit card payment transactions. For example, an issuer institution may provide an account identifier, such as a personal account number (PAN), to a user that uniquely identifies one or more accounts associated with that user. The account identifier may be embodied on a portable financial device, such as a physical financial instrument (e.g., a payment card), and/or may be electronic and used for electronic payments. In some non-limiting embodiments or aspects, an issuer institution may be associated with a bank identification number (BIN) that uniquely identifies the issuer institution. As used herein “issuer institution system” may refer to one or more computer systems operated by or on behalf of an issuer institution, such as a server computer executing one or more software applications. For example, an issuer institution system may include one or more authorization servers for authorizing a payment transaction.

As used herein, the term “merchant” may refer to an individual or entity that provides products and/or services, or access to products and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The terms “client device” and “user device,” as used herein, refer to any electronic device that is configured to communicate with one or more servers or remote devices and/or systems. A client device or user device may include a mobile device, a network-enabled appliance (e.g., a network-enabled television, refrigerator, thermostat, and/or the like), a computer, a POS system, and/or any other device or system capable of communicating with a network.

As used herein, the term “computing device” or “computer device” may refer to one or more electronic devices that are configured to directly or indirectly communicate with or over one or more networks. The computing device may be a mobile device, a desktop computer, or the like. Furthermore, the term “computer” may refer to any computing device that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Wallet™, Android Pay®, Apple Pay®, Samsung Pay®, and/or other like electronic payment systems. In some non-limiting examples, an issuer bank may be an electronic wallet provider.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a mobile device executing an electronic wallet application, a personal digital assistant (PDA), a security card, an access card, a wireless terminal, and/or a transponder, as examples. The portable financial device may include a volatile or a non-volatile memory to store information, such as an account identifier and/or a name of the account holder.

As used herein, the term “server” may refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, such as POS devices, directly or indirectly communicating in the network environment may constitute a “system,” such as a merchant's POS system.

As used herein, the term “acquirer” may refer to an entity licensed by the transaction service provider and/or approved by the transaction service provider to originate transactions using a portable financial device of the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

Provided are improved systems, devices, products, apparatus, and/or methods for co-located merchant anomaly detection.

Non-limiting embodiments or aspects of the present disclosure are directed to systems, methods, and computer program products for co-located merchant anomaly detection that obtain prior transaction data associated with a plurality of prior transactions, a first subset of the prior transactions being associated with a first merchant, a second subset of the prior transactions being associated with a second merchant different than the first merchant, each prior transaction of the plurality of prior transactions being associated with a same merchant location in the prior transaction data, each prior transaction of the plurality of prior transactions being associated with a same merchant name in the prior transaction data, the same merchant name being associated with the first merchant, a different merchant name than the same merchant name being associated with the second merchant, a first portion of the plurality of prior transactions being labeled as misclassified merchant transactions, and a second portion of the plurality of prior transactions being labeled as other merchant transactions; extract a plurality of features associated with the plurality of prior transactions from the prior transaction data; and train based on the plurality of features associated with the plurality of prior transactions and the labels for the prior transactions, a machine learning model to determine at least one of a prediction of whether a transaction is associated with the first merchant and a prediction of whether the transaction is associated with the second merchant. In this way, non-limiting embodiments or aspects of the present disclosure provide for generating co-located training data, extracting features, and predicting probabilities of a transaction belonging to a particular merchant, which enables more accurate volume reporting that helps achieve payment volume reporting compliance as well as providing more accurate promotions and offers in partnership with the correct merchant, which protects against incorrect offer generation or misclassified transactions attributed to the wrong merchant.

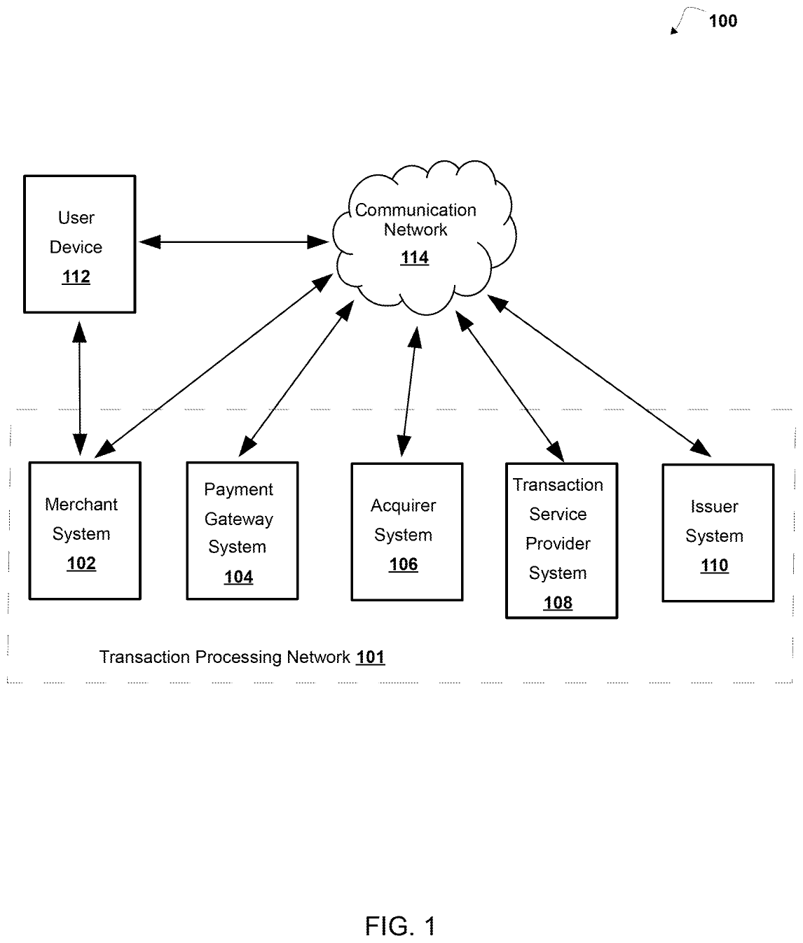

Referring now to FIG. 1, FIG. 1 is a diagram of an example environment 100 in which devices, systems, methods, and/or products described herein, may be implemented. As shown in FIG. 1, environment 100 includes transaction processing network 101, which may include merchant system 102, payment gateway system 104, acquirer system 106, transaction service provider system 108, issuer system 110, user device 112, and/or communication network 114. Transaction processing network 101, merchant system 102, payment gateway system 104, acquirer system 106, transaction service provider system 108, issuer system 110, and/or user device 112 may interconnect (e.g., establish a connection to communicate, etc.) via wired connections, wireless connections, or a combination of wired and wireless connections.

Merchant system 102 may include one or more devices capable of receiving information and/or data from payment gateway system 104, acquirer system 106, transaction service provider system 108, issuer system 110, and/or user device 112 (e.g., via communication network 114, etc.) and/or communicating information and/or data to payment gateway system 104, acquirer system 106, transaction service provider system 108, issuer system 110, and/or user device 112 (e.g., via communication network 114, etc.). Merchant system 102 may include a device capable of receiving information and/or data from user device 112 via a communication connection (e.g., an NFC communication connection, an RFID communication connection, a Bluetooth® communication connection, etc.) with user device 112, and/or communicating information and/or data to user device 112 via the communication connection. For example, merchant system 102 may include a computing device, such as a server, a group of servers, a client device, a group of client devices, and/or other like devices. In some non-limiting embodiments or aspects, merchant system 102 may be associated with a merchant as described herein. In some non-limiting embodiments or aspects, merchant system 102 may include one or more devices, such as computers, computer systems, and/or peripheral devices capable of being used by a merchant to conduct a payment transaction with a user. For example, merchant system 102 may include a POS device and/or a POS system.

Payment gateway system 104 may include one or more devices capable of receiving information and/or data from merchant system 102, acquirer system 106, transaction service provider system 108, issuer system 110, and/or user device 112 (e.g., via communication network 114, etc.) and/or communicating information and/or data to merchant system 102, acquirer system 106, transaction service provider system 108, issuer system 110, and/or user device 112 (e.g., via communication network 114, etc.). For example, payment gateway system 104 may include a computing device, such as a server, a group of servers, and/or other like devices. In some non-limiting embodiments or aspects, payment gateway system 104 is associated with a payment gateway as described herein.

Acquirer system 106 may include one or more devices capable of receiving information and/or data from merchant system 102, payment gateway system 104, transaction service provider system 108, issuer system 110, and/or user device 112 (e.g., via communication network 114, etc.) and/or communicating information and/or data to merchant system 102, payment gateway system 104, transaction service provider system 108, issuer system 110, and/or user device 112 (e.g., via communication network 114, etc.). For example, acquirer system 106 may include a computing device, such as a server, a group of servers, and/or other like devices. In some non-limiting embodiments or aspects, acquirer system 106 may be associated with an acquirer as described herein.

Transaction service provider system 108 may include one or more devices capable of receiving information and/or data from merchant system 102, payment gateway system 104, acquirer system 106, issuer system 110, and/or user device 112 (e.g., via communication network 114, etc.) and/or communicating information and/or data to merchant system 102, payment gateway system 104, acquirer system 106, issuer system 110, and/or user device 112 (e.g., via communication network 114, etc.). For example, transaction service provider system 108 may include a computing device, such as a server (e.g., a transaction processing server, etc.), a group of servers, and/or other like devices. In some non-limiting embodiments or aspects, transaction service provider system 108 may be associated with a transaction service provider as described herein. In some non-limiting embodiments or aspects, transaction service provider 108 may include and/or access one or more one or more internal and/or external databases including transaction data, and/or the like.

Issuer system 110 may include one or more devices capable of receiving information and/or data from merchant system 102, payment gateway system 104, acquirer system 106, transaction service provider system 108, and/or user device 112 (e.g., via communication network 114, etc.) and/or communicating information and/or data to merchant system 102, payment gateway system 104, acquirer system 106, transaction service provider system 108, and/or user device 112 (e.g., via communication network 114, etc.). For example, issuer system 110 may include a computing device, such as a server, a group of servers, and/or other like devices. In some non-limiting embodiments or aspects, issuer system 110 may be associated with an issuer institution as described herein. For example, issuer system 110 may be associated with an issuer institution that issued a payment account or instrument (e.g., a credit account, a debit account, a credit card, a debit card, etc.) to a user (e.g., a user associated with user device 112, etc.).

In some non-limiting embodiments or aspects, transaction processing network 101 includes a plurality of systems in a communication path for processing a transaction. For example, transaction processing network 101 can include merchant system 102, payment gateway system 104, acquirer system 106, transaction service provider system 108, and/or issuer system 110 in a communication path (e.g., a communication path, a communication channel, a communication network, etc.) for processing an electronic payment transaction. As an example, transaction processing network 101 can process (e.g., initiate, conduct, authorize, etc.) an electronic payment transaction via the communication path between merchant system 102, payment gateway system 104, acquirer system 106, transaction service provider system 108, and/or issuer system 110.

User device 112 may include one or more devices capable of receiving information and/or data from merchant system 102, payment gateway system 104, acquirer system 106, transaction service provider system 108, and/or issuer system 110 (e.g., via communication network 114, etc.) and/or communicating information and/or data to merchant system 102, payment gateway system 104, acquirer system 106, transaction service provider system 108, and/or issuer system 110 (e.g., via communication network 114, etc.). For example, user device 112 may include a client device and/or the like. In some non-limiting embodiments or aspects, user device 112 may be capable of receiving information (e.g., from merchant system 102, etc.) via a short range wireless communication connection (e.g., an NFC communication connection, an RFID communication connection, a Bluetooth® communication connection, and/or the like), and/or communicating information (e.g., to merchant system 102, etc.) via a short range wireless communication connection. In some non-limiting embodiments or aspects, user device 112 may include an application associated with user device 112, such as an application stored on user device 112, a mobile application (e.g., a mobile device application, a native application for a mobile device, a mobile cloud application for a mobile device, an electronic wallet application, a peer-to-peer payment transfer application, and/or the like) stored and/or executed on user device 112.

Communication network 114 may include one or more wired and/or wireless networks. For example, communication network 114 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and systems shown in FIG. 1 is provided as an example. There may be additional devices and/or systems, fewer devices and/or systems, different devices and/or systems, or differently arranged devices and/or systems than those shown in FIG. 1. Furthermore, two or more devices and/or systems shown in FIG. 1 may be implemented within a single device and/or system, or a single device and/or system shown in FIG. 1 may be implemented as multiple, distributed devices and/or systems. Additionally or alternatively, a set of devices and/or systems (e.g., one or more devices or systems) of environment 100 may perform one or more functions described as being performed by another set of devices or systems of environment 100.

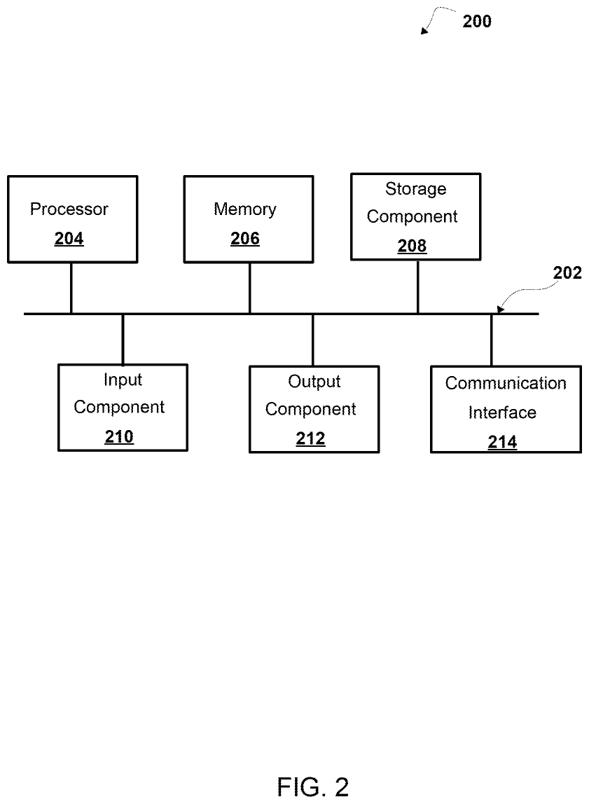

Referring now to FIG. 2, FIG. 2 is a diagram of example components of a device 200. Device 200 may correspond to one or more devices of transaction processing network 101, one or more devices of merchant system 102, one or more devices of payment gateway system 104, one or more devices of acquirer system 106, one or more devices of transaction service provider system 108, one or more devices of issuer system 110, user device 112 (e.g., one or more devices of a system of user device 112, etc.), and/or one or more devices of communication network 114. In some non-limiting embodiments or aspects, one or more devices of transaction processing network 101, one or more devices of merchant system 102, one or more devices of payment gateway system 104, one or more devices of acquirer system 106, one or more devices of transaction service provider system 108, one or more devices of issuer system 110, user device 112 (e.g., one or more devices of a system of user device 112, etc.), and/or one or more devices of communication network 114 can include at least one device 200 and/or at least one component of device 200. As shown in FIG. 2, device 200 may include a bus 202, a processor 204, memory 206, a storage component 208, an input component 210, an output component 212, and a communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

Memory 206 and/or storage component 208 may include data storage or one or more data structures (e.g., a database, etc.). Device 200 may be capable of receiving information from, storing information in, communicating information to, or searching information stored in the data storage or one or more data structures in memory 206 and/or storage component 208. For example, transaction service provider system 108 may include and/or access one or more internal and/or external databases that store transaction data associated with transactions processed and/or being processed in transaction processing network 101 (e.g., prior or historical transactions processed via transaction service provider system 108, etc.), and/or the like.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

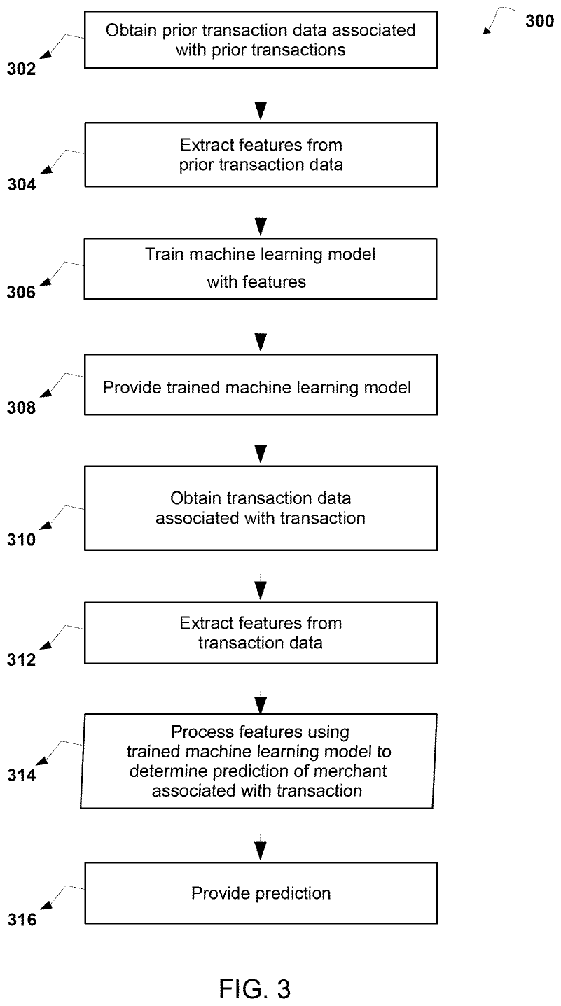

Referring now to FIG. 3, FIG. 3 is a flowchart of non-limiting embodiments or aspects of a process 300 for co-located merchant anomaly detection. In some non-limiting embodiments or aspects, one or more of the steps of process 300 may be performed (e.g., completely, partially, etc.) by transaction service provider system 108 (e.g., one or more devices of transaction service provider system 108). In some non-limiting embodiments or aspects, one or more of the steps of process 300 may be performed (e.g., completely, partially, etc.) by another device or a group of devices separate from or including transaction service provider system 108, such as merchant system 102 (e.g., one or more devices of merchant system 102), payment gateway system 104 (e.g., one or more devices of payment gateway system 104), acquirer system 106 (e.g., one or more devices of acquirer system 106), issuer system 110 (e.g., one or more devices of issuer system 110), and/or user device 112 (e.g., one or more devices of a system of user device 112).

As shown in FIG. 3, at step 302, process 300 includes obtaining prior transaction data associated with prior transactions. For example, transaction service provider system 108 may obtain prior transaction data associated with prior transactions. As an example, transaction service provider system 108 may obtain prior transaction data associated with a plurality of prior transactions. In such an example, a first subset of the prior transactions may be associated with a first merchant (e.g., a Walmart store), a second subset of the prior transactions may be associated with a second merchant (e.g., a MoneyGram store) different than the first merchant, each prior transaction of the plurality of prior transactions may be associated with a same merchant location (e.g., a same address, etc.) in the prior transaction data, each prior transaction of the plurality of prior transactions may be associated with a same merchant name (e.g., “Walmart”) in the prior transaction data, the same merchant name may be associated with the first merchant, a different merchant name (e.g., “MoneyGram”) than the same merchant name may be associated with the second merchant, a first portion of the plurality of prior transactions may be labeled as misclassified merchant transactions, and a second portion of the plurality of prior transactions may be labeled as other merchant transactions.

In some non-limiting embodiments or aspects, an nth subset of the prior transactions may be associated with an nth merchant (e.g., a Starbucks store) associated with the same merchant location and a further different merchant name (e.g., “Starbucks”).

In some non-limiting embodiments or aspects, prior transaction data may include parameters associated with a prior transaction, such as an account identifier (e.g., a PAN, etc.), a transaction amount, a transaction date and time, a type of products and/or services associated with the transaction, a conversion rate of currency, a type of currency, a merchant type, a merchant name, a merchant location, a merchant, a merchant category group (MCG), a merchant category code (MCC), and/or the like. In such an example, MCGs may include general categories under which MCCs fall, such as Travel, Lodging, Dining and Entertainment, Vehicle Expenses, Office Services and Merchandise, Cash Advance, Other, and/or the like. In such an example, an MCC is a four-digit number listed in ISO 18245 for retail financial services used to classify a business by the types of goods or services it provides.

In some non-limiting embodiments or aspects, the first merchant is associated with at least one known MCG (and/or MCC), the plurality of prior transactions is clustered in a plurality of groups according to MCGs (and/or MCCs) associated with the plurality of prior transactions in the prior transaction data, at least one group of the plurality of groups is identified as an anomalous group, the at least one anomalous group includes transactions outside the at least one known MCG (and/or MCC) associated with the first merchant, and the transactions in the at least one anomalous group are labeled as the misclassified merchant transactions or the other merchant transactions according to the at least one known MCG (and/or MCC) associated with the first merchant. In some non-limiting embodiments or aspects, the second merchant is associated with at least one known MCG (and/or MCC), the plurality of prior transactions is clustered in a plurality of groups according to MCGs (and/or MCCs) associated with the plurality of prior transactions in the prior transaction data, at least one group of the plurality of groups is identified as an anomalous group, the at least one anomalous group includes transactions outside the at least one known MCG (and/or MCC) associated with the second merchant, and the transactions in the at least one anomalous group are labeled as the misclassified merchant transactions or the other merchant transactions according to the at least one known MCG (and/or MCC) associated with the second merchant. In some non-limiting embodiments or aspects, the nth merchant is associated with at least one known MCG (and/or MCC), the plurality of prior transactions is clustered in a plurality of groups according to MCGs (and/or MCCs) associated with the plurality of prior transactions in the prior transaction data, at least one group of the plurality of groups is identified as an anomalous group, the at least one anomalous group includes transactions outside the at least one known MCG (and/or MCC) associated with the nth merchant, and the transactions in the at least one anomalous group are labeled as the misclassified merchant transactions or the other merchant transactions according to the at least one known MCG (and/or MCC) associated with the nth merchant.

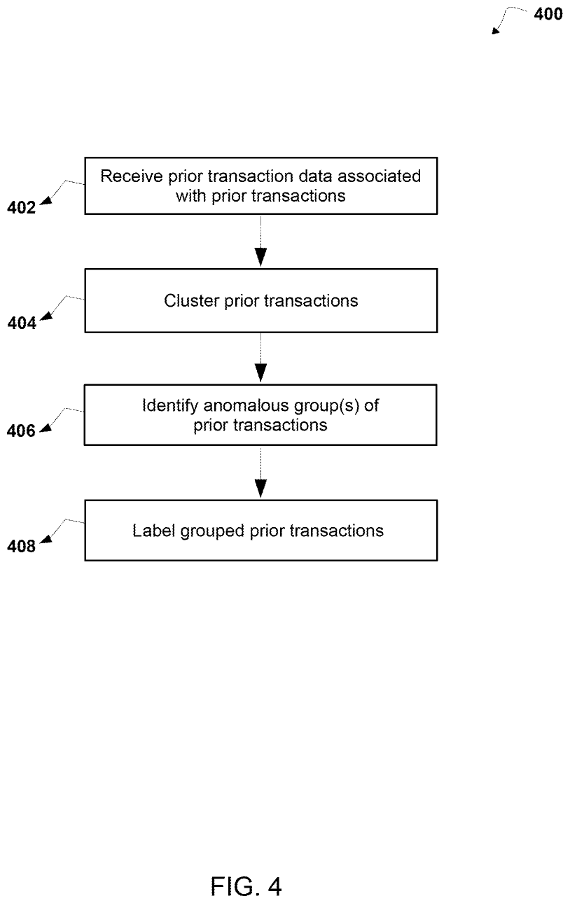

Further details regarding non-limiting embodiments or aspects of step 302 of process 300 are provided below with regard to FIG. 4.

As shown in FIG. 3, at step 304, process 300 includes extracting features from prior transaction data. For example, transaction service provider system 108 may extract features from prior transaction data. As an example, transaction service provider system 108 may extract a plurality of features associated with the plurality of prior transactions from the prior transaction data.

In some non-limiting embodiments or aspects, a feature associated with a prior transaction may include at least one of: a MCG, a MCC, a merchant name (e.g., an n-gram), an average transaction amount associated with a merchant name (e.g., average ticket size), a transaction time associated with a prior transaction (e.g., a transaction time of day, day of week, month, season, etc.), or any combination thereof.

As shown in FIG. 3, at step 306, process 300 includes training a machine learning model with features. For example, transaction service provider system 108 may train a machine learning model with features. As an example, transaction service provider system 108 may train, based on the plurality of features associated with the plurality of prior transactions and the labels for the prior transactions, a machine learning model to determine at least one of a prediction of whether a transaction is associated with the first merchant and a prediction of whether the transaction is associated with the second merchant. In such an example, a machine learning model may include at least one random forest model.

In some non-limiting embodiments or aspects, training a machine learning model includes training, based on the plurality of features associated with the plurality of prior transactions and the labels for the prior transactions, a first machine learning classifier associated with the first merchant to determine a first prediction of whether the transaction is associated with the first merchant; training, based on the plurality of features associated with the plurality of prior transactions and the labels for the prior transactions, a second machine learning classifier associated with the second merchant to determine a second prediction of whether the transaction is associated with the second merchant; and/or training, based on the plurality of features associated with the plurality of prior transactions and the labels for the prior transaction, an nth machine learning classifier associated with an nth merchant to determine a first prediction of whether the transaction is associated with the nth merchant.

As shown in FIG. 3, at step 308, process 300 includes providing a trained machine learning model. For example, transaction service provider system 108 may provide a trained machine learning model. As an example, transaction service provider system 108 may provide the trained machine learning model (e.g., a first machine learning classifier associated with a first merchant, a second machine learning classifier associated with a second merchant, an nth machine learning classifier associated with an nth merchant, etc.). In such an example, transaction service provider system 108 may store the trained machine learning model and/or communicate the trained machine learning model to merchant system 102, payment gateway system 104, acquirer system 106, issuer system 110, and/or user device 112.

As shown in FIG. 3, at step 310, process 300 includes obtaining transaction data associated with a transaction. For example, transaction service provider system 108 may obtain transaction data associated with a transaction. As an example, transaction service provider system 108 may obtain transaction data associated with the transaction (e.g., a transaction initiated and/or currently being processed in transaction processing network 101, etc.).

In some non-limiting embodiments or aspects, transaction data may include parameters associated with a transaction, such as an account identifier (e.g., a PAN, etc.), a transaction amount, a transaction date and time, a type of products and/or services associated with the transaction, a conversion rate of currency, a type of currency, a merchant type, a merchant name, a merchant location, a merchant, a MCG, a MCC, and/or the like.

As shown in FIG. 3, at step 312, process 300 includes extracting features from transaction data. For example, transaction service provider system 108 may extract features from transaction data. As an example, transaction service provider system 108 may extract a plurality of features associated with the transaction from the transaction data.

In some non-limiting embodiments or aspects, a feature associated with a transaction may include at least one of: a MCG, a MCC, a merchant name (e.g., an n-gram), an average transaction amount associated with a merchant name (e.g., average ticket size), a transaction time associated with a transaction (e.g., a transaction time of day, day of week, month, season, etc.), or any combination thereof.

As shown in FIG. 3, at step 314, process 300 includes processing features using a trained machine learning model to determine a prediction of a merchant associated with a transaction. For example, transaction service provider system 108 may process features using a trained machine learning model to determine a prediction of a merchant associated with a transaction. As an example, transaction service provider system 108 may process, using the trained machine learning model, the plurality of features to determine the first prediction of whether the transaction is associated with the first merchant, the second prediction of whether the transaction is associated with the second merchant, and/or the nth prediction of whether the transaction is associated with the nth merchant. In such an example, the first prediction may include a first probability associated with the transaction being associated with the first merchant, the second prediction may include a second probability associated with the transaction being associated with the second merchant, and/or the nth prediction may include an nth probability associated with the transaction being associated with the nth merchant.

As shown in FIG. 3, at step 316, process 300 includes providing a prediction. For example, transaction service provider system 108 may provide a prediction. As an example, transaction service provider system 108 may provide the first prediction of whether the transaction is associated with the first merchant, the second prediction of whether the transaction is associated with the second merchant, and/or the nth prediction of whether the transaction is associated with the nth merchant.

In some non-limiting embodiments or aspects, transaction service provider system 108 may provide an offer or promotion to a customer associated with the merchant determined to be associated with the transaction (e.g., the merchant having the highest probability, etc.).

Referring now to FIG. 4, FIG. 4 is a flowchart of non-limiting embodiments or aspects of a process 400 for co-located merchant anomaly detection. In some non-limiting embodiments or aspects, one or more of the steps of process 400 may be performed (e.g., completely, partially, etc.) by transaction service provider system 108 (e.g., one or more devices of transaction service provider system 108). In some non-limiting embodiments or aspects, one or more of the steps of process 400 may be performed (e.g., completely, partially, etc.) by another device or a group of devices separate from or including transaction service provider system 108, such as merchant system 102 (e.g., one or more devices of merchant system 102), payment gateway system 104 (e.g., one or more devices of payment gateway system 104), acquirer system 106 (e.g., one or more devices of acquirer system 106), issuer system 110 (e.g., one or more devices of issuer system 110), and/or user device 112 (e.g., one or more devices of a system of user device 112).

As shown in FIG. 4, at step 402, process 400 includes receiving prior transaction data associated with prior transactions. For example, transaction service provider system 108 may receive prior transaction data associated with prior transactions. As an example, transaction service provider system 108 may receive prior transaction data associated with a plurality of prior transactions.

As shown in FIG. 4, at step 404, process 400 includes clustering prior transactions. For example, transaction service provider system 108 may cluster prior transactions according to the prior transaction data associated with the prior transactions. As an example, transaction service provider system 108 may cluster prior transactions according to MCGs and/or MCCs associated with the prior transactions in the prior transaction data.

In one non-limiting embodiment or aspect, clustering prior transactions includes applying at least one of the following algorithms: k-means clustering, hierarchical clustering, a neural network, a decision tree, or any combination thereof, to the prior transaction data associated with the plurality of prior transactions.

As shown in FIG. 4, at step 406, process 400 includes identifying at least one anomalous group of prior transactions. For example, transaction service provider system 108 may identify at least one anomalous group of prior transactions. As an example, transaction service provider system 108 may identify at least one group of the plurality of groups as an anomalous group, the at least one anomalous group including transactions outside the at least one known MCG (and/or MCC) associated with the first merchant (and/or the second merchant, and/or the nth merchant). For example, a transaction with a merchant name “mrch1” where the merchant is known to be operating in known market segments (e.g., seg 1, seg 2, seg 3) may be misclassified as “mrch1” due to the transaction market segment associated with the transaction in the transaction data being seg 4, because “mrch1” does not operate in that segment or group and, thus, the transaction may be assigned to an anomalous cluster.

As shown in FIG. 4, at step 408, process 400 includes labeling grouped prior transactions. For example, transaction service provider system 108 may label grouped prior transactions. As an example, transaction service provider system 108 may label the transactions in the at least one anomalous group as misclassified merchant transactions (e.g., a true/correct label) or other merchant transactions (e.g., a false/incorrect label) according to the at least one known MCG (and/or MCC) associated with the first merchant (and/or the second merchant, and/or the nth merchant). For example, transaction service provider system 108 may use domain knowledge of market segments or groups to correct/label training data for the particular merchant clusters and segregate the misclassified transactions into an “others” cluster. As an example, domain knowledge may use information for a merchant related to the market segments in which the merchant operates. For example, for first and second merchants that operate in a gas station category, domain knowledge may indicate that a transaction with a grocery store merchant category associated with a name of the first or second merchant is incorrect as these merchants do not operate in the retail/grocery market domain. In such an example, domain knowledge includes publicly available market segment operation information.

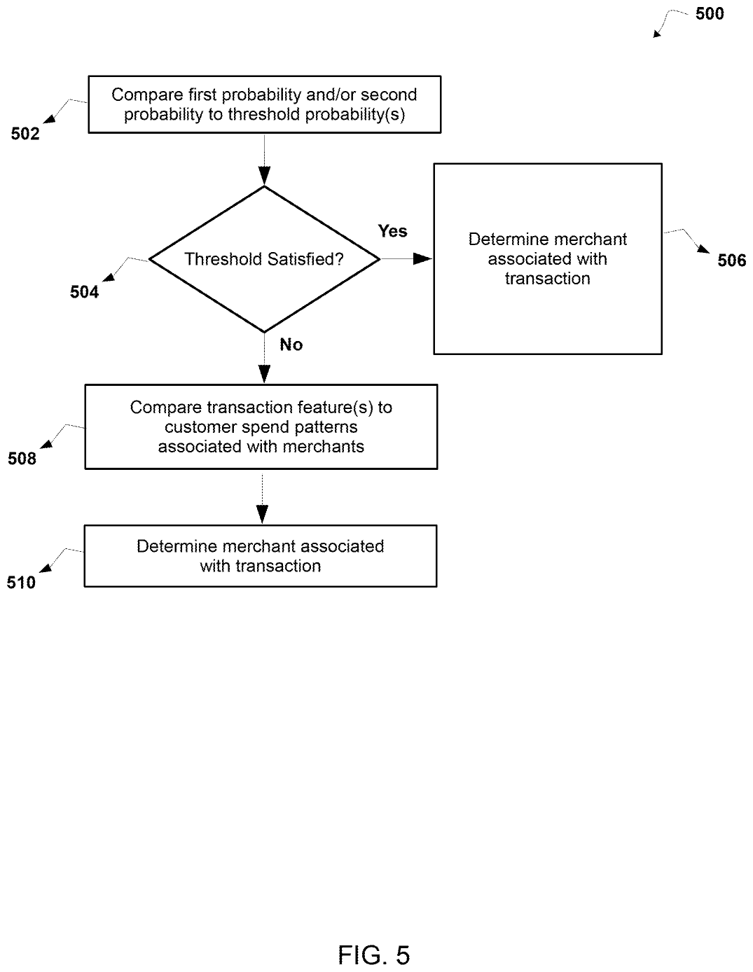

Referring now to FIG. 5, FIG. 5 is a flowchart of non-limiting embodiments or aspects of a process 500 for co-located merchant anomaly detection. In some non-limiting embodiments or aspects, one or more of the steps of process 400 may be performed (e.g., completely, partially, etc.) by transaction service provider system 108 (e.g., one or more devices of transaction service provider system 108). In some non-limiting embodiments or aspects, one or more of the steps of process 400 may be performed (e.g., completely, partially, etc.) by another device or a group of devices separate from or including transaction service provider system 108, such as merchant system 102 (e.g., one or more devices of merchant system 102), payment gateway system 104 (e.g., one or more devices of payment gateway system 104), acquirer system 106 (e.g., one or more devices of acquirer system 106), issuer system 110 (e.g., one or more devices of issuer system 110), and/or user device 112 (e.g., one or more devices of a system of user device 112).

As shown in FIG. 5, at step 502, process 500 includes comparing at least one of a first probability and a second probability to at least one threshold probability. For example, transaction service provider system 108 may compare at least one of a first probability and a second probability to at least one threshold probability. As an example, transaction service provider system 108 may compare the first probability associated with the transaction being associated with the first merchant to at least one first threshold probability and the second probability associated with the transaction being associated with the second merchant to at least one second threshold probability.

As shown in FIG. 5, at step 504, process 500 includes determining whether at least one threshold probability is satisfied. For example, transaction service provider system 108 may determine whether at least one threshold probability is satisfied. As an example, transaction service provider system 108 may determine whether the first probability associated with the transaction being associated with the first merchant satisfies the at least one first threshold probability and/or whether the second probability associated with the transaction being associated with the second merchant satisfies the at least one second threshold probability.

As shown in FIG. 5, at step 506, process 500 includes determining a merchant associated with a transaction. For example, transaction service provider system 108 may determine a merchant associated with a transaction. As an example, in response to determining in step 504 that the first probability associated with the transaction being associated with the first merchant satisfies the at least one first threshold probability and/or the second probability associated with the transaction being associated with the second merchant satisfies the at least one second threshold probability, transaction service provider system 108 may determine that the transaction is associated with the first merchant or the second merchant. In such an example, transaction service provider system 108 may determine that the transaction is associated with the merchant having the higher or highest probability. As an example, if the first prediction includes a first probability of 80% that satisfies at least one first threshold (e.g., a threshold of 60% or more probability) and the second prediction includes a second probability of 30% that satisfies at least one second threshold (e.g., a threshold of 40% or less probability), transaction service provider system 108 may determine that the transaction is associated with (e.g., occurred at, was initiated by, etc.) the first merchant.

As shown in FIG. 5, at step 508, process 500 includes comparing at least one transaction feature to customer spend patterns associated with merchants. For example, transaction service provider system 108 may compare at least one transaction feature to customer spend patterns associated with merchants. As an example, in response to determining in step 504 that the first probability associated with the transaction being associated with the first merchant fails to satisfy the at least one first threshold probability and/or the second probability associated with the transaction being associated with the second merchant fails to satisfy the at least one second threshold probability, transaction service provider system 108 may compare at least one feature of the plurality of features associated with the transaction to a first customer spend pattern associated with the first merchant and a second customer spend pattern associated with the second merchant. For example, if the first prediction includes a first probability of 55% that fails to satisfy at least one first threshold (e.g., a threshold of 60% or more probability and/or a threshold of 40% or less probability) and the second prediction includes a second probability of 45% that satisfies at least one second threshold (e.g., a threshold of 40% or less probability and/or a threshold of 60% or more probability), transaction service provider system 108 may compare at least one feature of the plurality of features associated with the transaction to a first customer spend pattern associated with the first merchant and a second customer spend pattern associated with the second merchant.

In some non-limiting embodiments or aspects, a customer spend pattern may include a transaction amount associated with a merchant (e.g., a minimum, an average, a maximum, etc.), a transaction time associated with a merchant (e.g., a minimum, an average, a maximum, etc.), a number of transactions per a type of product associated with a merchant, or any combination thereof.

As shown in FIG. 5, at step 510, process 500 includes determining a merchant associated with a transaction. For example, transaction service provider system 108 may determine a merchant associated with a transaction. As an example, transaction service provider system 108 may determine the transaction is associated with the first merchant or the second merchant associated with a customer spend pattern that is closer or closest to the at least one feature associated with the transaction. For example, if a transaction associated with a first transaction time is closer to an average transaction time associated with the second merchant than an average transaction time associated with the first merchant, transaction service provider system 108 may determine that the transaction is associated with (e.g., occurred at, was initiated by, etc.) the second merchant.

Although embodiments or aspects have been described in detail for the purpose of illustration and description, it is to be understood that such detail is solely for that purpose and that embodiments or aspects are not limited to the disclosed embodiments or aspects, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method, comprising:
obtaining, with at least one processor, prior transaction data associated with a plurality of prior transactions, wherein a first subset of the prior transactions is associated with a first merchant, wherein a second subset of the prior transactions is associated with a second merchant different than the first merchant, wherein each prior transaction of the plurality of prior transactions is associated with a same merchant location in the prior transaction data, wherein each prior transaction of the plurality of prior transactions is associated with a same merchant name in the prior transaction data, wherein the same merchant name is associated with the first merchant, wherein a different merchant name than the same merchant name is associated with the second merchant, wherein a first portion of the plurality of prior transactions is labeled as misclassified merchant transactions, and wherein a second portion of the plurality of prior transactions is labeled as other merchant transactions;
extracting, with at least one processor, a plurality of features associated with the plurality of prior transactions from the prior transaction data; and
training, with at least one processor, based on the plurality of features associated with the plurality of prior transactions and the labels for the prior transactions, a machine learning model to determine at least one of a prediction of whether a transaction is associated with the first merchant and a prediction of whether the transaction is associated with the second merchant.

2. The computer-implemented method of claim 1, wherein training the machine learning model further comprises:
training, based on the plurality of features associated with the plurality of prior transactions and the labels for the prior transactions, a first machine learning classifier associated with the first merchant to determine a first prediction of whether the transaction is associated with the first merchant; and
training, based on the plurality of features associated with the plurality of prior transactions and the labels for the prior transactions, a second machine learning classifier associated with the second merchant to determine a second prediction of whether the transaction is associated with the second merchant.

3. The computer-implemented method of claim 2, further comprising:
providing, with at least one processor, the trained machine learning model;
obtaining, with at least one processor, transaction data associated with the transaction;
extracting, with at least one processor, a plurality of features associated with the transaction from the transaction data; and
processing, with at least one processor using the trained machine learning model, the plurality of features to determine the first prediction of whether the transaction is associated with the first merchant and the second prediction of whether the transaction is associated with the second merchant, wherein the first prediction includes a first probability associated with the transaction being associated with the first merchant, and wherein the second prediction includes a second probability associated with the transaction being associated with the second merchant.

4. The computer-implemented method of claim 3, further comprising:
comparing, with at least one processor, at least one of the first probability and the second probability to at least one threshold probability;
determining, with at least one processor, based on the comparison, that the at least one of the first probability and the second probability fails to satisfy the at least one threshold probability;
in response to determining that the at least one of the first probability and the second probability fails to satisfy the at least one threshold probability, comparing, with at least one processor, at least one feature of the plurality of features associated with the transaction to a first customer spend pattern associated with the first merchant and a second customer spend pattern associated with the second merchant; and
determining, with at least one processor, based on the comparison, that the transaction is associated with the first merchant or the second merchant.

5. The computer-implemented method of claim 1, wherein the first merchant is associated with at least one known merchant category group, wherein the plurality of prior transactions is clustered in a plurality of groups according to merchant category groups associated with the plurality of prior transactions in the prior transaction data, wherein at least one group of the plurality of groups is identified as an anomalous group, wherein the at least one anomalous group includes transactions outside the at least one known merchant category group associated with the first merchant, and wherein the transactions in the at least one anomalous group are labeled as the misclassified merchant transactions or the other merchant transactions according to the at least one known merchant category group associated with the first merchant.

6. The computer-implemented method of claim 1, wherein the plurality of features associated with the plurality of prior transactions includes at least one of: a merchant category code (MCC), a merchant name, an average transaction amount associated with a merchant name, a transaction time associated with a prior transaction, or any combination thereof.

7. The computer-implemented method of claim 1, wherein the machine learning model includes at least one random forest model.

8. A computing system comprising:
one or more processors programmed and/or configured to:
obtain prior transaction data associated with a plurality of prior transactions, wherein a first subset of the prior transactions is associated with a first merchant, wherein a second subset of the prior transactions is associated with a second merchant different than the first merchant, wherein each prior transaction of the plurality of prior transactions is associated with a same merchant location in the prior transaction data, wherein each prior transaction of the plurality of prior transactions is associated with a same merchant name in the prior transaction data, wherein the same merchant name is associated with the first merchant, wherein a different merchant name than the same merchant name is associated with the second merchant, wherein a first portion of the plurality of prior transactions is labeled as misclassified merchant transactions, and wherein a second portion of the plurality of prior transactions is labeled as other merchant transactions;
extract a plurality of features associated with the plurality of prior transactions from the prior transaction data; and
train, based on the plurality of features associated with the plurality of prior transactions and the labels for the prior transactions, a machine learning model to determine at least one of a prediction of whether a transaction is associated with the first merchant and a prediction of whether the transaction is associated with the second merchant.

9. The computing system of claim 8, wherein the one or more processors train the machine learning model by:
training, based on the plurality of features associated with the plurality of prior transactions and the labels for the prior transactions, a first machine learning classifier associated with the first merchant to determine a first prediction of whether the transaction is associated with the first merchant; and
training, based on the plurality of features associated with the plurality of prior transactions and the labels for the prior transactions, a second machine learning classifier associated with the second merchant to determine a second prediction of whether the transaction is associated with the second merchant.

10. The computing system of claim 9, wherein the one or more processors are further programmed and/or configured to:
provide the trained machine learning model;
obtain transaction data associated with the transaction;
extract a plurality of features associated with the transaction from the transaction data; and
process, using the trained machine learning model, the plurality of features to determine the first prediction of whether the transaction is associated with the first merchant and the second prediction of whether the transaction is associated with the second merchant, wherein the first prediction includes a first probability associated with the transaction being associated with the first merchant, and wherein the second prediction includes a second probability associated with the transaction being associated with the second merchant.

11. The computing system of claim 10, wherein the one or more processors are further programmed and/or configured to:
compare at least one of the first probability and the second probability to at least one threshold probability;
determine, based on the comparison, that the at least one of the first probability and the second probability fails to satisfy the at least one threshold probability;
in response to determining that the at least one of the first probability and the second probability fails to satisfy the at least one threshold probability, compare at least one feature of the plurality of features associated with the transaction to a first customer spend pattern associated with the first merchant and a second customer spend pattern associated with the second merchant; and
determine, based on the comparison, that the transaction is associated with the first merchant or the second merchant.

12. The computing system of claim 8, wherein the first merchant is associated with at least one known merchant category group, wherein the plurality of prior transactions is clustered in a plurality of groups according to merchant category groups associated with the plurality of prior transactions in the prior transaction data, wherein at least one group of the plurality of groups is identified as an anomalous group, wherein the at least one anomalous group includes transactions outside the at least one known merchant category group associated with the first merchant, and wherein the transactions in the at least one anomalous group are labeled as the misclassified merchant transactions or the other merchant transactions according to the at least one known merchant category group associated with the first merchant.

13. The computing system of claim 8, wherein the plurality of features associated with the plurality of prior transactions includes at least one of: a merchant category code (MCC), a merchant name, an average transaction amount associated with a merchant name, a transaction time associated with a prior transaction, or any combination thereof.

14. The computing system of claim 8, wherein the machine learning model includes at least one random forest model.

15. A computer program product comprising at least one non-transitory computer-readable medium including program instructions that, when executed by at least one processor, cause the at least one processor to:
obtain prior transaction data associated with a plurality of prior transactions, wherein a first subset of the prior transactions is associated with a first merchant, wherein a second subset of the prior transactions is associated with a second merchant different than the first merchant, wherein each prior transaction of the plurality of prior transactions is associated with a same merchant location in the prior transaction data, wherein each prior transaction of the plurality of prior transactions is associated with a same merchant name in the prior transaction data, wherein the same merchant name is associated with the first merchant, wherein a different merchant name than the same merchant name is associated with the second merchant, wherein a first portion of the plurality of prior transactions is labeled as misclassified merchant transactions, and wherein a second portion of the plurality of prior transactions is labeled as other merchant transactions;
extract a plurality of features associated with the plurality of prior transactions from the prior transaction data; and
train, based on the plurality of features associated with the plurality of prior transactions and the labels for the prior transactions, a machine learning model to determine at least one of a prediction of whether a transaction is associated with the first merchant and a prediction of whether the transaction is associated with the second merchant.

16. The computer program product of claim 15, wherein the instructions cause the at least one processor to train the machine learning model by:
training, based on the plurality of features associated with the plurality of prior transactions and the labels for the prior transactions, a first machine learning classifier associated with the first merchant to determine a first prediction of whether the transaction is associated with the first merchant; and
training, based on the plurality of features associated with the plurality of prior transactions and the labels for the prior transactions, a second machine learning classifier associated with the second merchant to determine a second prediction of whether the transaction is associated with the second merchant.

17. The computer program product of claim 16, wherein the instructions further cause the at least one processor to:
provide the trained machine learning model;
obtain transaction data associated with the transaction;
extract a plurality of features associated with the transaction from the transaction data; and
process, using the trained machine learning model, the plurality of features to determine the first prediction of whether the transaction is associated with the first merchant and the second prediction of whether the transaction is associated with the second merchant, wherein the first prediction includes a first probability associated with the transaction being associated with the first merchant, and wherein the second prediction includes a second probability associated with the transaction being associated with the second merchant.

18. The computer program product of claim 17, wherein the instructions further cause the at least one processor to:
compare at least one of the first probability and the second probability to at least one threshold probability;
determine, based on the comparison, that the at least one of the first probability and the second probability fails to satisfy the at least one threshold probability;
in response to determining that the at least one of the first probability and the second probability fails to satisfy the at least one threshold probability, compare, at least one feature of the plurality of features associated with the transaction to a first customer spend pattern associated with the first merchant and a second customer spend pattern associated with the second merchant; and
determine, based on the comparison, that the transaction is associated with the first merchant or the second merchant.

19. The computer program product of claim 15, wherein the first merchant is associated with at least one known merchant category group, wherein the plurality of prior transactions is clustered in a plurality of groups according to merchant category groups associated with the plurality of prior transactions in the prior transaction data, wherein at least one group of the plurality of groups is identified as an anomalous group, wherein the at least one anomalous group includes transactions outside the at least one known merchant category group associated with the first merchant, and wherein the transactions in the at least one anomalous group are labeled as the misclassified merchant transactions or the other merchant transactions according to the at least one known merchant category group associated with the first merchant.

20. The computer program product of claim 15, wherein the plurality of features associated with the plurality of prior transactions includes at least one of: a merchant category code (MCC), a merchant name, an average transaction amount associated with a merchant name, a transaction time associated with a prior transaction, or any combination thereof.
